(19) United States
(12) Patent Application Publication
(10) Pub. No.: US 2015/0186857 A1
(43) Pub. Date: Jul. 2, 2015

(54) USER TERMINAL CONTROL SYSTEM AND METHOD

(71) Applicant: I-DESIGN MULTI MEDIA LIMITED, Dundee (GB)

(72) Inventor: Richard Swinfen, Dundee (GB)

(21) Appl. No.: 14/416,191

(22) PCT Filed: Jul. 23, 2013
(86) PCT No.: PCT/GB2013/051962

§ 371 Date: Jan. 21, 2015

(30) Foreign Application Priority Data
Jul. 23, 2012 (GB) 1213072.0

(51) Int. Cl. G06Q 20/10; G06Q 20/18

(52) U.S. Cl. CPC G06Q 20/1085; G06Q 40/02; G06Q 20/18

(57) ABSTRACT

A method of controlling operation of a user terminal, wherein the user terminal comprises a controller for controlling operation of the user terminal, and the user terminal further comprises a plurality of devices, wherein in normal operation the controller is responsive to data received from at least one of the devices, and the method comprises providing, from a source other than said at least one of the devices, control data to the controller, the control data comprising data that the controller interprets as being received from said at least one the devices.

### FIELD OF THE INVENTION

The present invention relates to a control system and method for a user terminal, such as a self-service terminal, for example an ATM.

### BACKGROUND TO THE INVENTION

User terminals, for example self-service terminals such as ATMs, are very widely used for a variety of purposes. Large financial institutions, such as banks, typically maintain networks of many thousands of ATMs. The ATMs in a particular network, or maintained by a particular organisation, may include a variety of different types or models and a range of different ages and functionalities, are often produced by different manufacturers, and may have different software or operating systems installed.

The diversity of ATMs makes maintenance of ATMs and the production of new software for such ATMs difficult. For example, it may be necessary to produce many different versions of a new ATM application to ensure that it is compatible with each of the different types of ATM in a network. Such difficulties are becoming particularly acute as there has been a move towards providing additional functions or services via ATMs, which require the replacement of applications with updated, often more sophisticated, applications.

The CEN/XFS standard architecture was developed in order to ensure software compatibility across different ATMs. The CEN/XFS architecture provides a common API layer, also referred to as a service provide layer, that comprises API or service provider modules that provide for communication with and control of hardware devices (for example a keypad, an audio output, or a receipt printer) included in the ATM.

Each hardware manufacture provides service provider modules that include XFS-compliant software, for example dynamically linked libraries (DLLs) that enable communication with and control of hardware devices produced by that manufacturer. Each service provider module provides for a minimum level of commands for associated hardware devices as defined by the CEN/XFS standard.

In operation XFS-compliant applications in the application layer of the ATM send XFS-compliant commands to the appropriate service provider modules in the service provider layer, which can convert the commands to the appropriate hardware-specific format if necessary, and pass the commands on to the appropriate hardware device driver. Similarly, data can be received from hardware devices by the service provider modules and forwarded to the appropriate application in the application in the XFS-compliant format. By using standard XFS commands an application can, in principle, communicate with any installed hardware device if an XFS service provider module is provided for the hardware device. The CEN/XFS architecture does not generally provide for simultaneous access to hardware devices by more than one application, and even serial access to the same hardware device by different applications can cause system crashes. Such system crashes may be avoided by synchronisation of the applications at the application layer, but that is not straightforward, requires modification to the applications and does not allow for addition or replacement of applications.

Each ATM can include service provider modules for different hardware manufacturers (for example NCR, Diebold and Wincor Nixdorf) and hardware devices. The service provider modules that are to be used in a particular ATM are defined by keys stored in a registry of the ATM processing system. The ATM can include an XFS management layer in addition to the service provider layer, which directs commands or other messages to the appropriate service provider module based on the registry keys.

Although the CEN/XFS architecture improves the compatibility of ATM software across different hardware platforms, it is directed to only standard ATM functions. More sophisticated applications directed to more complex ATM functions are not supported under the XFS architecture. The provision of more sophisticated ATM functions, or the modification of existing ATM functionality, can require modification or replacement of the existing ATM application. That can be challenging as the ATM applications installed at different ATMs across an ATM network may be different, and have different configurations and properties. For example, different ATM applications at different ATMs may have be coded or installed years apart, may have been produced by different entities, and may be specific to a particular ATM.

### SUMMARY OF THE INVENTION

In a first independent aspect of the invention there is provided a method of controlling operation of a user terminal, wherein the user terminal comprises control means (for example a controller) for controlling operation of the user terminal, and the user terminal further comprises a plurality of devices, wherein in normal operation the control means (for example, the controller) is responsive to data received from at least one of the devices, and the method comprises providing, from a source other than said at least one of the devices, control data to the control means (for example, the controller), the control data comprising data that the control means (for example, the controller) interprets as being received from said at least one the devices.

Thus, the user interaction process may be affected or controlled by providing control data to the control means (for example an ATM or other controller). Thus, operation of the control means may be controlled. That may in turn enable control of operation of the user terminal by a component other than, or in addition to, the control means, which in turn can enable modification of the functionality of an ATM, for example providing modified or additional functionality without having to modify or replace the ATM application itself.

The control means may be responsive to the data received from said at least one of the devices to perform a user interaction process. The control data may thus affect the user interaction process and may, for example, enable controlling of the user interaction process by the source.

The control data may comprise simulated data that simulates data that may be received from said at least one of the devices. The control data may be in the same or similar format as data that may be received from said at least one device.

The control data may comprise at least one instruction and/or may comprise status data or content data.

The control data may be in the same or similar format as user input data, for example, data received from a user input device. The user input device may comprise a keypad device. The control data may be in the same or similar format as keypress data. The data may comprise simulated keypress data.

The control means, for example the controller, may comprise an application, for example an ATM application.

The source may comprise, or form part of, a further control means. The further control means, for example a further controller, may comprise a further application. The further control means may be installed in the user terminal.

The method may comprise installing the source in the user terminal. The method may comprise installing the source without affecting the configuration of the control means.

The user terminal may comprise an ATM. Alternatively or additionally, the user terminal may comprise any other suitable type of self-service terminal, for example for providing goods or services to a user, for example a ticket purchase or dispensing terminal, or an automated information kiosk.

The at least one device may comprise at least one of: a user input device, for example a keypad device and/or at least one button; a display device; a cash dispenser device or other dispenser device; a card reader device or other device for reading verifying the identity of a user for instance a reader for reading a contactless card or fob; a camera.

The method may comprise providing further control data and/or content to at least one of said plurality of devices. The further control data may comprise simulated data that simulates data that may be provided by said control means in normal operation. The further control data may be in the same or similar format, and/or have the same or similar content, as data that may be provided by said control means in normal operation. The method may comprise providing said further control data and/or content from said source.

The further control data may be in the same or similar format, and/or have the same or similar content as instructions that may be provided by the control means to instruct actions forming part of a user interaction process.

The method may comprise intercepting at least one message sent from the control means or said at least one device. The method may comprise at least one of blocking, delaying, modifying or replacing said at least one message.

The method may comprise providing at least one message to the control means to place the control means in a desired state and/or to cause the control means to perform at least one desired action. The method may comprise providing at least one message to the at least one device to place the at least one device in a desired state and/or to cause the at least one device to perform a desired action.

The or each message may comprise said control data. The or each message may comprise a data packet.

The intercepting of said at least one message may comprise intercepting said at least one message using an interception means for example an interception device or unit. The interception device or unit may comprise an API and/or DLL, for example a proxy API and/or DLL.

The method may comprise redirecting at least one message sent by the control means or the at least one device. The redirecting may comprise redirecting the at least one message to the interception means or the further control means. The method may comprise causing the redirecting of the at least one message by modifying a registry key or other path or device identifier

The control means may be configured to control operation of the user terminal to provide a user interaction process, for example a user transaction process.

The user interaction process may comprise a sequence of stages. The control means may have, in operation, a plurality of states, each state corresponding to a respective one of the plurality of stages.

The user interaction process may comprise the display of a sequence of display screens. The user interaction process may comprise the display of a sequence of interlinked menus.

The method may comprise detecting a status of the control means and/or a stage of the user interaction process, for example using a state detection means.

The user interaction process may comprise providing content data representing content to one of the devices, for example by the control means, and outputting the content to a user by the device. The method may comprise monitoring the content data and/or the content and determining a state of the user interaction process from the content and/or the content data.

The user interaction process may comprise the display of a sequence of display screens, and the method may comprise identifying from the content or content data a display screen of the sequence.

The content data may comprise pixel data items representative of pixels to be displayed on the display device, at least one of the pixel data items may comprise an identifier identifying a display screen represented by the display data, and the method may comprise reading said at least one of the pixel data items and determining the stage of the user interaction process or state of the control means from a value of said at least one pixel data item.

The identifier may be encoded on the value of the said at least one pixel data item, for example on a colour component value of said at least one pixel data item.

Said at least one pixel data item may comprise at least one pixel data item representative of a predetermined number of pixels, wherein the predetermined number of pixels is optionally less than or equal to at least one of 10, 6, and 4.

The identifier may be included in pixel data items representative of pixels for display at or near a predetermined location on the display of the display device, wherein optionally the predetermined location comprises an edge or corner of the display.

The method may comprise performing a clipping process so that only a subset of pixels are rendered by the display device. The subset of pixels may comprise or consist of said pixel data items representing said identifier. The method may comprise reading the identifier and in response to determining from the identifier that the content data is to be displayed removing the clipping, for example so that all of the content data is displayed.

In a further independent aspect of the invention there is provided a method of displaying data comprising obtaining screen data representative of a screen to be rendered, applying a clipping so that only a selected portion of the screen is rendered, determining an identifier from the rendered portion of the screen, and determining from the identifier whether to render the whole screen.

The method may comprise providing content to a user that is additional or alternative to content provided to a user in the user interaction process.

The method may comprise determining whether the stage of the user interaction process matches a predetermined stage, or whether the state of the control means matches a predetermined state, and providing the additional or alternative content in response to the determined state or stage matching the predetermined state or stage.

The method may comprise providing the additional or alternative content in response to detection of a predetermined one of the display screens of the sequence of display screens, and optionally replacing or overlaying the predetermined one of the display screens with the additional or alternative content.

The source, for example the further control means, may be configured to provide control data to the control means and/or to at least one of the devices thereby to replace at least part of the user interaction process with an alternative process, for example an alternative interaction process. The alternative interaction process may comprise displaying at least one alternative user interface, for example at least one alternative screen. The alternative interaction process may comprise displaying a sequence of alternative user interfaces, for example a sequence of alternative screens.

The method may comprise selectively activating or deactivating at least one user input device, for example at least one button or portion of touchscreen, under control of the further controller, during or as part of the alternative interaction process. The method may comprise monitoring for user input from said selectively activated or deactivated user input device(s). The method may comprise determining an outcome of the alternative interaction process, for example determining a desired or requested action. The method may comprise performing the desired or requested action, for example under control of the further controller. The control data may comprise control data configured to make the controller perform or request the desired or requested action.

The method may comprise at least one of blocking, delaying, modifying or replacing at least one message from at least one of the control devices to the control means, thereby to maintain the control means in a desired state whilst the alternative interaction process is performed.

The content and/or timing of the provided control data and/or other data may ensure that the controller is not aware of at least part of the alternative interaction process.

The alternative interaction process may comprise display of a personalised menu or other screen to a user. The alternative interaction process may comprise display of a favourites menu by the or a display device. The favourites menu may comprise at least one option that has commonly been performed, or most commonly performed, by a particular user, a particular group of users, or all users.

The method may comprise identifying a user and providing the personalised menu or other screen, for example the favourites menu, in dependence on the identity of the user. The method may comprise selecting at least one option to include on the personalised menu or other screen in dependence on the identity of the user.

The method may comprise determining the personalised menu or other screen, for example at least one option to included on the personalised menu or other screen, in dependence on a usage history, for example a usage history of the user or a group of users that includes the user. The usage history may comprise a history of transactions performed using user terminals of a network of user terminals.

The method may comprise collecting usage data for a plurality of users by the further control means, for example the further application.

The method may comprise obtaining a user request for a transaction via a mobile device, remote user device or other user device, and the alternative interaction process may comprise automatically performing the user request.

The mobile or other user device may comprise, for example, a mobile phone, for instance a smart phone, a personal computer, and/or a laptop.

The method may comprise obtaining the user request in advance of the user interacting with the user terminal, for example in advance of the user beginning a user interaction process at the user terminal. The method may comprise monitoring for the user to begin interacting with the user terminal, for example for the user to insert a card or provide an other verification device at the user terminal. The method may comprise automatically performing the user request in response to the user beginning to interact with the user terminal and/or in response to a user interaction process of the user with the user terminal reaching a predetermined stage (for example, the user entering a PIN or otherwise verifying their identity correctly).

The method may comprise receiving the user request at a server, identifying at least one user terminal where the user may wish the request to be performed and selectively transmitting user request data to the identified at least one user terminal.

The user request received at the server may comprise at least one identifier representing at least one user terminal and the server may identify the at least one user terminal from the at least one user terminal.

The user request received at the server may comprise or be associated with location data representative of the present location or expected future location of the user and/or mobile device and the method may comprise identifying the at least one user in dependence on the present or expected future location.

The source, for example the further controller, may be configured to perform automatically a balance enquiry to obtain balance data, and the alternative interaction process comprises displaying the balance data.

The alternative interaction process may comprise at least one of a cash withdrawal transaction process, a cash deposit transaction process, a balance enquiry.

The controller may be configured to control operation of the user terminal to provide a process comprising the display of a sequence of display screens, each display screen represented by content data provided under control of the controller. The content data may comprise pixel data items representative of pixels to be displayed on the display device, at least one of the pixel data items comprising or representing an identifier. The method may comprise performing a clipping process so that only a subset of pixels are rendered by the display device, the subset of pixels comprising said pixel data items representing said identifier. The method may comprise reading said at least one of the pixel data items to determine said identifier.

The method may comprise identifying a display screen using the identifier, or determining from the identifier at least one of a stage of the process or a state of the controller.

The identifier may be encoded on the value of the said at least one pixel data item, for example on a colour component value of said at least one pixel data item.

The method may comprise, in response to determining from the identifier that the content data is to be displayed, removing the clipping, for example so that substantially all of the pixels are displayed.

The method may comprise installing the source in the user terminal without affecting the configuration of the controller.

The at least one device may comprise at least one of: a user input device; a display device; a cash dispenser device or other dispenser device; a card reader or other reader device; a device for verifying the identity of a user; a camera.

The further controller may comprise at least one further device for blocking, delaying, modifying, redirecting or replacing at least one message sent between the controller and the least one device.

The at least one further device may comprise at least one of an API, a DLL, a service provider module, a proxy API, a proxy DLL, a proxy service provider module, a hooking mechanism.

The control data provided to the controller may comprise time data for modifying the timing of an operation by the controller.

The providing of the control data to the controller may be such as to respond to or prevent a timeout process of the application.

The control data may be configured such as to prevent a beep, or other audio output operation.

The providing of the control data to the controller may comprise inserting code into runtime memory.

The method may further comprise modifying at least one registry key and/or inserting code into runtime memory to replace or modify code in the runtime memory from the controller.

In a further independent aspect of the invention there is provided a system for controlling operation of a user terminal, wherein the user terminal comprises control means (for example a controller) for controlling operation of the user terminal, and the user terminal further comprises a plurality of devices, wherein in normal operation the control means (for example the controller) is responsive to data received from at least one of the devices to perform a user interaction process, and the system comprises further control means (for example a further controller) for providing control data to the control means (for example the controller), the control data comprising data that the control means (for example the controller) interprets as being received from said at least one the devices.

The control means (for example the controller) may comprise an application, and the further control means (for example the further controller) may comprise a further application.

The system may comprise interception means for intercepting at least one message sent by the control means or the at least one device. The interception means may be configured to at least one of block, delay, modify or replace said at least one message.

The system may comprise redirection means for redirecting at least one message sent by the control means or the at least one device. The redirection means may comprise a modified registry key or other path or device identifier. The redirection means may be configured to direct the at least one message to the further control means and/or to the interception means.

The interception means may comprise an interception device or unit, for example an API and/or DLL, a proxy API and/or DLL.

The system may comprise means for performing any one of, combination of, or each of the processes described herein.

The further controller may comprise at least one further device for blocking, delaying, modifying, redirecting or replacing at least one message sent between the controller and the least one device.

The at least one further device may comprise at least one of an API, a DLL, a service provider module, a proxy API, a proxy DLL, a proxy service provider module, a hooking mechanism.

The at least one further device may be configured to modify at least one registry key and/or inserting code into runtime memory to replace or modify code in the runtime memory from the controller.

The system may be configured to perform a method as claimed or described herein.

The user terminal controller may be configured to communicate with a remote server, for example a financial transaction server, and the further controller may be configured to communicate with a further server remote from the user terminal.

The further controller may be configured to collect usage data representative of at least one transaction by a user, and to provide the data to the further server.

The usage data may comprise or be derived from application state and/or user input data, for example keypress data or screen touch data.

The system may further comprise the further server, wherein the further server may be configured to determine user history or user favourites for at least one user in dependence on the usage data.

In another aspect of the invention that may be provided independently, there is provided a system for monitoring operation of a user terminal, wherein the user terminal comprises a controller for controlling operation of the user terminal, the user terminal further comprises a plurality of devices, and the controller is configured to control at least one user interaction process, and the system comprises a monitoring device that is configured to at least one of read, block, delay, modify, redirect or replace at least one message sent between the controller and the least one device, wherein the monitoring device is configured to collect usage data representative of at least one transaction by a user.

The usage data may comprise or be derived from user input data, for example keypress data or screen touch data obtained from the at least one message.

The monitoring device may be configured to transmit the usage data to a remote server.

In another independent aspect of the invention, there is provided a server comprising means for receiving a request for a user interaction process from a mobile device or other user device, and means for transmitting request data representing the request to at least one user terminal.

In a further independent aspect of the invention there is provided a method of monitoring operation of a user terminal, wherein the user terminal comprises a controller for controlling operation of the user terminal, the user terminal further comprises a plurality of devices, and the controller is configured to control at least one user interaction process, and the method comprises: collecting usage data representative of at least one transaction by a user using a monitoring device that is configured to at least one of read, block, delay, modify, redirect or replace at least one message sent between the controller and the least one device.

In another independent aspect of the invention there is provided a method comprising receiving a request for a user interaction process from a mobile device or other user device, and transmitting request data representing the request to at least one user terminal.

In a further independent aspect of the invention there is provided a server comprising means for receiving a request for a user interaction process from a mobile device or other user device, and means for transmitting request data representing the request to at least one user terminal. The server may be configured to identify at least one user terminal and to transmit the request data to the identified user terminal. The server may be configured to identify the at least one user terminal from terminal identifier data or location data sent with the request.

In another independent aspect of the invention there is provided a server configured to receive from a user terminal identification data identifying a user, and to transmit to the user terminal user preference data, for example favourite transaction data, corresponding to the identified user.

In another independent aspect of the invention there is provided a method of controlling a user terminal (for example an ATM), wherein the user terminal comprises a control means (for example an application) for providing a user transaction or other user interaction process of the user terminal, the user terminal comprises a user input device for providing user input and the method comprises providing at least one simulated user input signal to the control means to control the user transaction or other user interaction process.

The user input device may comprise at least one key and the at least one simulated user input signal may comprise at least one simulated key input signal.

The method may comprise intercepting at least one user input signal from the user input device and replacing the intercepted at least one user input signal with the at least one simulated user input signal.

The user transaction or other user interaction process may comprise displaying a sequence of screens to a user on a display device, the control means, in normal operation, may replace one screen of the sequence with another screen of the sequence in response to user input; and the method may further comprise providing the at least one simulated user input signal to the control means to cause the control means to send an instruction and/or image data to the display device to display a screen of the sequence.

The method may further comprise at least partially overlaying or replacing said screen of the sequence with a replacement image by sending a further instruction and/or further image data to the display device. The method may further comprise synchronising the sending of the further instruction and/or further image data to the display device with the sending of the at least one simulated user input signal to the control means.

The synchronising of the sending of the further instruction and/or further image data to the display device with the sending of the at least one simulated user input signal to the control means may be such as to minimize or eliminate the time said screen is displayed before being overlaid or replaced by the replacement image.

Said display screen may comprise at least one user input option, and said replacement image may comprise at least one replacement user input option.

The control means may comprise an application and the method may further comprise installing on a user terminal on which the application is already installed a software component, for example a further application, for performing the method.

The installation of the software component may be such as to not alter the application.

In another independent aspect of the invention there is provided a method of controlling a user terminal (for example an ATM), wherein the user terminal is configured to provide a user transaction process, the user transaction process comprises displaying a sequence of screens to a user on a display device of the user terminal, and the method comprises determining an identity of the user, selecting a replacement image in dependence on the identity of the user, at least partially overlaying or replacing a screen of the sequence with the replacement image, thereby to display a modified or replacement screen, wherein the modified or replacement screen comprises information relating to the transaction process.

The method may comprise determining in dependence on the identity of the user a tailored menu comprising at least one transaction option, and the modified or replacement screen may comprise the tailored menu.

Said screen of the sequence that is overlaid or replaced may comprise a menu comprising at least one transaction option, and the method may thus comprise replacing said menu with said tailored menu determined in dependence on the identity of the user.

The method may comprise selecting transaction options to include in the tailored menu based on the user's transaction history or predefined user preferences.

The tailored menu may comprise at least one of an option to withdraw a specified amount of cash, or an option to check a balance.

Said screen that is overlaid or replaced may be at a first position in the sequence of display screens, and the tailored menu appearing on the modified or replacement screen may comprise at least one transaction option that, in normal operation, first appears on a screen at a second, later position in the sequence of display screens.

Thus, for example, if it is known that a user almost always withdraws say £10 the tailored menu might comprise 1) the option to withdraw £10 and 2) the option to go back to the standard main menu. The standard main menu, usually accessed immediately after the user has entered their PIN successfully, may be overlaid/replaced by the tailored menu according to the method thus saving time for the user.

The user terminal may comprise a control means that in normal operation sends a sequence of instructions and/or image data to the display device thereby to cause the display device to display the sequence of screens, and the at least partial overlaying or replacement of said screen of the sequence with a replacement image may be performed by sending a further instruction and/or further image data to the display device independently of the control means.

The control means may comprise an application and the method may further comprise installing on a user terminal on which the application is already installed a software component for performing the method. The installation of the software component may be such as to not alter the application.

In another independent aspect of the invention there is provided a method of controlling a user terminal (for example an ATM), wherein the user terminal comprises a control means (for example an application) for providing a user transaction process of the user terminal, the user terminal comprises a user input device for providing user input, and the method comprises receiving at the user terminal from a user's mobile device at least one instruction, and performing by the user terminal a user transaction in accordance with the at least one instruction.

For example, a user can select a transaction (eg “withdraw £20”) using software installed on his mobile phone whilst queuing to use an ATM. The instruction is sent from the mobile phone to the ATM. When the user enters his PIN successfully at the ATM, the ATM then immediately performs the requested transaction without requiring the user to navigate through the transaction screens using the user input device in the standard way.

The at least one instruction may be sent from the user's mobile device to the user terminal via a remote server.

The method may comprise representing the at least one instruction using at least one simulated user input signal, and providing the at least one simulated user input signal to the control means thereby to cause the control means to control the user terminal to perform the user transaction.

The user input device may comprise at least one key and the at least one simulated user input signal comprises at least one simulated key input signal.

The control means may comprise an application and the method may further comprise installing on a user terminal on which the application is already installed a software component, for example a further application, for performing the method. The installation of the software component may be such as to not alter the application.

Any feature in one aspect of the invention may be applied to other aspects of the invention, in any appropriate combination. In particular, apparatus features may be applied to method features and vice versa.

### BRIEF DESCRIPTION OF THE DRAWINGS

At least one embodiment of the invention will now be described, by way of example only, with reference to the accompanying drawings, in which:

FIG. 1 is a schematic illustration of a user terminal according to an embodiment;

FIG. 2 is a schematic illustration of a processing system according to an embodiment;

FIG. 3 is a flow chart illustrating operation of the embodiment of FIG. 2 to display a favourites menu to a user;

FIG. 4 is a schematic illustration of a processing system according to an embodiment;

FIG. 5 is a schematic illustration of a favourites menu;

FIG. 6 is a schematic illustration of a processing system according to a further embodiment;

FIG. 7 is a schematic illustration of a mobile device according to an embodiment; and

FIG. 8 is a flowchart illustrating in overview a method of performing a user transaction using the system of FIG. 6.

### DETAILED DESCRIPTION OF EMBODIMENTS

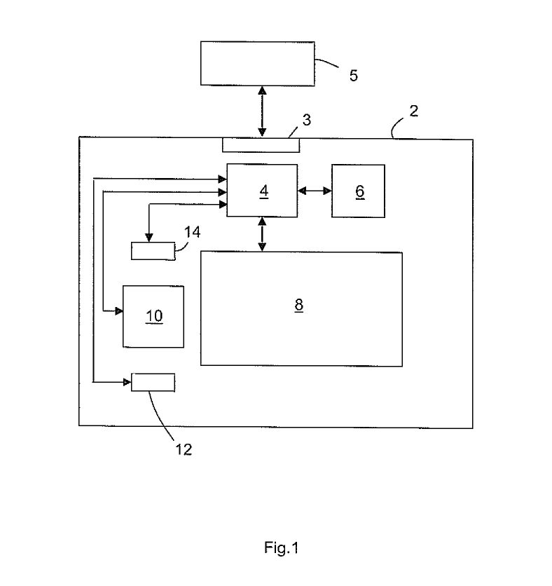

Various components of an ATM 2 are illustrated schematically in FIG. 1. The ATM 2 includes a processor 4 connected to a data store 6 and various hardware devices, for example a display device 8, a keypad device 10, a card reader device 12 and a receipt printer 14. The ATM 2 also includes a cash dispensing device (not shown) and a slot (not shown) through which cash is dispensed by the cash dispensing device. The ATM 2 also includes a slot (not shown) that can also be used to dispense a receipt printed by the receipt printer 14. The card reader device 12 can read magnetic stripes and/or smartcard chips.

In the embodiment of FIG. 1, the processor is an Intel compatible P1 233 MHz processor with 64 Mb of RAM configured to operate under any 32 bit Windows operating system. The memory 6 comprises a 100 Mb hard disk, the display device 8 is a 16 bit colour screen device and the receipt printer 14 is a thermal enabled printer. The keypad device 10 comprises a number pad and control buttons (for example, cancel and enter) and also includes function buttons either side of the display for interface control.

The ATM 2 also includes network communication circuitry 3 and software (not shown) that enables it to communicate with a server 5 via a secure network. The server 5 is able to provide data to the ATM 2, and to other ATMs in the network, and provide authorisation for user transactions, for example financial transactions, in accordance with known techniques. The server is also able to download and remotely install software on, and monitor operation of, the ATM 2 and other ATMs in the network.

Any suitable server 5 can be used. In one example, the server 5 comprises a Dual-Core Intel Xeon Processor 5100 Series 2 GHz (or Intel compatible with equivalent performance), 2 GB RAM, 2×140 GB hard disks (mirrored) with SQL Server database, Microsoft Windows 2003 Server, Microsoft SQL Server 2000 SP2 or 2005 access to the SQL Server database, SQL Server BCP, ADO 2.8, MSXML 3.0, DirectX 9.0c, IIS 6.0, and anti-virus software.

In operation, the processor 4 is able to communicate with and control operation of the various hardware devices, under control of applications running on the processor. Upon power-up of the ATM 2 a basic input-output system (BIOS) is booted from non-volatile storage (not shown) included in the processor 4, and the operating system, applications, API components and device drivers are then installed from the memory 6 by the processor 4 to form an ATM processing system.

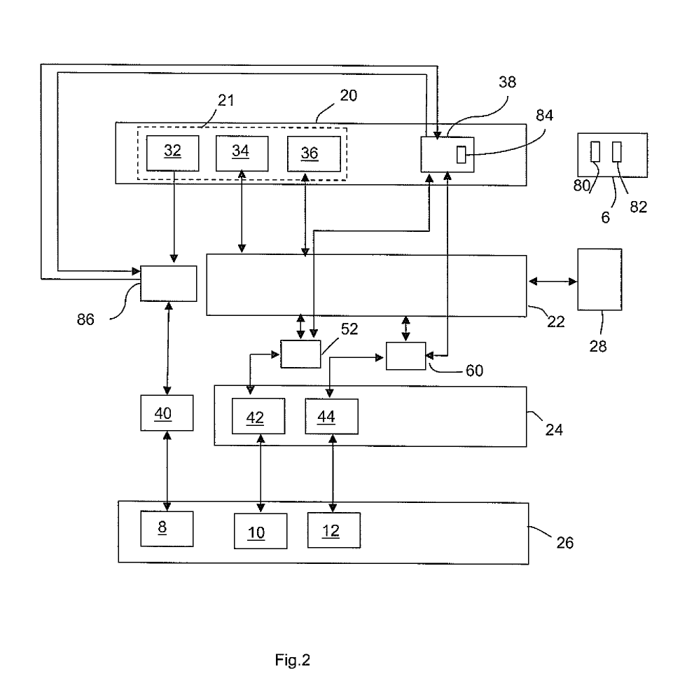

The ATM processing system is illustrated schematically in overview in FIG. 2, and comprises an application layer 20, an XFS manager 22, an API layer in the form of XFS layer 24, a hardware layer 26 and a registry 28.

The application layer comprises an ATM application 21. The ATM application 21 includes a plurality of application modules for controlling operation of, and/or communicating with hardware devices of the terminal 2. Three application modules 32, 34, 36 are shown by way of example. The ATM application 21 is configured to control operation of a user interaction process performed by the terminal 2. The application 21 and application modules 32, 34, 36 are provided under any XFS-compatible application environment, for example Kalignite, NCR APTRA or a Wincor application environment, such as WincorProTopas. Examples of ATM applications include NCR Advance NDC or Edge, Wincor ProCash NDC, and Diebold Agilis.

In the embodiment of FIG. 1, the application layer 21 also includes a further application 38. In one mode of operation, the application 38 is provided and installed by a third party rather than by the ATM manufacturer or administrator. No changes to the application 21 are needed to install the further application 38 or proxy APIs 52, 60 described below.

The XFS layer 24 comprises a plurality of service provider modules, and three service provider modules 40, 42, 44 are illustrated by way of example. The illustrated service provider modules 40, 42, 44 support communication with and control of the particular display 8, keypad device 10, and card reader device 12 included in the ATM 2. Other service provider modules, not shown, are included in the XFS layer to support communication with and control of other hardware devices included in the ATM 2. A further middleware layer (not shown), for example KAL Kalignite, Phoenix VISTAatm, or Nexus, is also provided in some variants to simplify the implementation of the ATM application.

Further service provider modules, not shown, are also usually included in the XFS layer 24 that are able to support communication with hardware devices of other manufacturers, for example keypads, card reader devices and receipt printers of other types or other manufacturers, but are usually not used unless a hardware device, for example keypad device 10, is replaced with a hardware device of another type or another manufacturer, for example a keypad device of another type.

The system also generally includes a manufacturer-specific and/or hardware-specific platform layer (not shown), which can be considered to form part of the hardware layer 26, and comprises the various drivers or other components needed to control operation of the physical hardware devices. The service provider modules 40, 42, 44 are usually compatible with a single type of platform layer, but the XFS messages sent from the application layer are non-platform specific and so the service provider modules 40, 42, 44 are able to communicate with and receive instructions from any ATM application.

In operation, the application 21 controls the basic functionality of the ATM 2. For example, the application controls the sequence of operations required for withdrawal of cash by a user, or other user functions. Each sequence of operations may require, for example, one or more of the reading of a user's card, the entry and checking of a user's PIN, the entry and checking of a user's personal and financial details, such as account balance and withdrawal limit, the retrieval of requested information, and the dispensing of cash. Each sequence of operations also usually requires the display of predetermined screens including instructions or other information at predetermined points in the process.

In order to perform the sequence of operations, the application 21 instructs the hardware devices to perform requested actions and receive data from the hardware devices. Messages between the application layer and the hardware layer are sent via the XFS Manager 22 and the XFS layer 24.

The registry 28 stores keys, also referred to as strings, that map hardware device calls to particular service provider modules in the service provider layer. The XFS manager 22 is in communication with the registry 28, and upon initialisation of the system or ATM application 21 the XFS manager 22 reads the appropriate keys from the registry 28 for the installed hardware devices and provides the keys to the application layer, so that subsequent hardware device messages from the ATM application 21 are directed to the service provider identified by the appropriate key.

As can be seen from FIG. 2, the processing system includes additional components 52, 60 in the path between the XFS manager 22 and the API layer, in this case the service provider layer 24. The additional components 52, 60 are arranged to intercept messages between the application layer and the XFS layer. In the embodiment of FIG. 2, the additional components are proxy API 52 and proxy API 60 located in the path between the XFS manager 22 and the service provider layer 24. The proxy APIs 52, 60 are CEN XFS SPI compliant pass-through service providers.

A proxy in this context can be considered to be a replacement, alternative or complement for a particular part of an application, API or other software. The proxy may comprise a DLL. The proxy may provide at least some of the functionality that the application, API or other software provides in normal operation. In addition, it may be able to observe data flows, or if required modify a process or data to meet an objective. In the example of FIG. 2, the proxy API 60 comprises a DLL that is used as a replacement or complement for the card reader XFS service provider module 44 (which, as discussed is a standardised API which controls the behaviour of the card reader driver specific to the ATM platform) and the proxy API 52 comprises a DLL that is used as a replacement or complement for the card reader XFS service provider module 42 (which is a standardised API which controls the behaviour of the keypad device driver specific to the ATM platform).

In the example of FIG. 2, the proxy APIs 52, 60 are installed onto an existing system and are directed to control of and communication with two of the hardware devices, in this case the card reader device 12 and the keypad device 10 that comprises a number pad, control buttons and function buttons. In order to ensure that messages from the application layer 20 are directed to the proxy APIs 52, 60 rather than going directly from the XFS manager 22 to the existing service provider module 42, 44 keys stored in the registry 28 for the hardware devices are altered.

For example, an appropriate key may be:—

### HKLM\SOFTWARE\XFS\SERVICE_PROVIDERS\IDC\DLLNAME

where, in this case, the card reader device is referred to as the XFS IDC device. In this case, DLLNAME is the key, and the string value of the key is the filename of the DLL. The string value of the key is altered in this example to refer to the filename of the proxy API 52. A similar alteration in a registry key is made in respect of the other proxy API 60.

In alternative embodiments, interception of messages by the proxy APIs 52, 60 or other interception devices or units is obtained without modification of registry keys. For example, the interception device or unit can monitor for messages on the communication path between the application and the service provider module, and intercept at a suitable point on the path during the communication process. Alternatively, a proxy DLL file of the proxy API can be placed in a folder higher up in the search hierarchy used by the application to load the service provider module 42, 44 or DLL—thereby forcing the proxy DLL file to be loaded instead.

By replacing an existing service provider module or DLL, it might seem that it is necessary to implement all of the normal functions of the service provider module in the proxy API in order to control the corresponding device. However, in the embodiment of FIG. 2 that is avoided by ensuring that in response to each call to a function in a proxy, the original functions of the original service provider module are called by the proxy API, and the proxy API only processes data or modifies behaviour where necessary to provide the desired additional functionality. Alternatively, in other embodiments, a proxy API may implement all of the normal functions of a corresponding service provider. The service provides may be bypassed in such alternative embodiments.

In the embodiment of FIG. 2, the proxy API 60 passes all messages, for example all commands, received from the application layer on to the existing, hardware vendor's IDC CEN XFS compliant service provider module 44, which passes the commands on to the card reader device 12. Messages from the card reader device 12 in response to commands are passed back to the service provider module 44, which in turn passes them back to the ATM application 21 along the path back to the application layer. In this case, the path passes via the proxy API 60. In variants of the embodiment, messages are sent between the proxy API 60 and the hardware layer without going through, or without calling functions from, the service provider module 44.

The proxy API 60 is able to process the received information and other messages and pass data included in the messages to the further application 38 in addition to the ATM application 21. In the case of proxy API 60, the data is card data read by the card reader device 12 and includes one or more of, for example, cardholder name, Primary Account Number (PAN) and card ‘application’ (meaning issuer/institution responsible for the credit/debit processing, such as Mastercard or Visa).

The further application 38 is able to identify a particular user, or particular user account, from the information received from the proxy API 60.

In operation, the proxy API 52 also receives messages, for example commands, received from the application layer and intended for the existing, hardware vendor's IDC CEN XFS compliant service provider module 42, which is configured to pass messages on to the keypad device 10. The commands may, for example, be commands to activate particular function buttons, the number pad, or particular control buttons ready to receive input from a user.

Depending on the state of the application 10 and/or the user interaction process, the proxy API 52 may not pass on the messages to the service provider module 42 unmodified but may instead pass on modified or alternative messages, for example modified or alternative commands. The modifications or alternative messages may be provided to the proxy API 52 by the further application 38. For instance, the proxy API 52 may receive from the application layer a command to activate particular function keys but may instead pass on a message activating other function keys or the number pad or control keys.

The proxy API 52 also receives messages from the keypad device 10 via the service provider module 42. It is a significant feature of the embodiment of FIG. 2, that depending on the state of the application 10 and/or the user interaction process, the proxy API 60 may not pass on the messages to the application 21 unmodified but may instead pass on modified or alternative messages. The modifications or alternative messages may be provided to the proxy API 52 by the further application 38.

A message received by proxy API 52 from the keypad device 10 via the service provider module 42 may comprise keypress data representative of one or more keypresses by the user, or other user input data. The application 21 may be configured to take action in dependence of such keypress data. For example, the application 21 may use such keypress data or other user input data to decide whether to move to a further stage of a user interaction process. The keypress data or other user input data may represent a selection by a user of a particular option, for example a selection of withdrawal of a particular amount of cash.

A replacement or modified message provided by the proxy API 52 to the application 21 may comprise substitute keypress data, or other user input data, indicating that a different key or keys were pressed, or other user input provided, than indicated by the message received from the keypad device 10. Alternatively, the proxy API 52 may merely block or delay the message received from the service provider module, thus leaving the application 21 to conclude no key had been pressed, without providing an alternative or modified message to the application 21.

The further application 38, via operation of the proxy APIs 52, 60 is able to take control of operation of hardware or other devices, in this example the keypad device 10 and card reader device 12, in place of the application 21 by blocking, delaying or modifying messages from the application 21 and by providing substitute, alternative or additional messages to the hardware or other devices.

It is a feature of the embodiment of FIG. 2 that the further application 38 can also control the state of the application 21 and/or a user interaction process by blocking, delaying or modifying messages from hardware or other devices, and by providing substitute, alternative or additional messages to the application 21. Thus the state and actions of the hardware devices and the state of the application 21 and/or the user interaction process can be disconnected, under control of the further application 38, and the further application 38 is able to take control, from the application 21, of a user interaction process.

Proxy APIs can be used to amend or replace data, for example messages, sent between the application layer and any other hardware devices, as well as or instead of the keypad device 10 and the card reader device 12 if desired.

In the embodiment of FIG. 2, the further application 38 is able to communicate with and control operation of the display device 8 as well as the keypad device 10, the card reader device 12 or other hardware devices. It is usual for the ATM application to control the display device 8 directly via the operating system layer using a standard Windows or other operating system component, for example the Windows GDI or DirectX APIs, rather than via the XFS layer.

On all ATM platforms, display data in the form or screen files 80 held on the hard disk 6 of the ATM 2 are loaded and rendered by the ATM application 21 on the display device 8 to prompt user interaction. These are known as the user interface screens. In normal operation, the ATM application 21 retrieves from amongst the screen files 80 the appropriate screen file for each stage in a transaction and sends the screen file data to the display device 8 via the operating system 86 for rendering and display of the corresponding user interface screen during that stage of the transaction. It will be understood that there may be further components between the operating system and the display device 8, for example device drivers, but these are not shown for clarity.

In the embodiment of FIG. 2, the further application 38 is arranged to display further or alternative screens on the display device 8 during a transaction.

The screen files 82 for the further screens displayed on the display device 8 by the further application 38 are stored on the hard disk 6. In operation, the further application 38 determines the state of the ATM application 21, usually the stage that has been reached in a user interaction or transaction, selects an appropriate further for display at that stage, retrieves the corresponding screen file from the hard disk 6 and sends the screen file data to the display device 8 via the operating system 86 for display of the selected further screen. The selected further screen either replaces or overlays the current user interaction screen on the display device 8.

The screen data files contains data in one of a range of formats which is presented on the consumer display using an appropriate renderer. Formats for the screen data files include, for example, JPEG, PCX and HTML.

The application 38 comprises a state detection module 84 that determines the state of the ATM application 21, for example the stage that has been reached in a user transaction or other interaction.

The state detection module 84 determines the stage that has been reached by matching the screen file data sent to the display device by the ATM application to screen file data that may be displayed at stages of the transaction or other interaction.

In one embodiment, the state detection module 84 compares the entirety of the screen file data that is sent to the stored screen file data. However that is time consuming, and also requires the state detection module 84 to have access to data representing all possible screens that may be displayed (which can vary significantly across different ATMs and different ATM applications).

In another mode of operation, the application 38 is configured to determine the state of the ATM application, based on what content is being presented to the user during the transaction, by employing an encoding/decoding or ‘codec’ technique. The encoding is applied to the screen data files which are used by the ATM application 21. The application 38 is configured to perform the encoding by modifying the screen files so that when the ATM application 21 renders them, a distinction can be detected by the further application 38 almost instantaneously. Each of the screen files can be encoded to include identification data, for example an identifier that enables identification of the display screen represented by that screen file.

An operator is able to predetermine which files represent particular stages of the interaction or transaction, and that information can be downloaded to the ATM 2 from the server 5. The application 38 receives the information from the server and uses it to encode the specified screens using an algorithm that results in a small, but specific modification to what will be rendered on the display.

The process to encode screen fifes is specific to each file format. However, for each file format the algorithm implemented by the embodiment of FIG. 2 is similar and comprises modifying the first few pixels (for example in the top left corner) of the image to contain coloured pixels representing an ASCII string code. The code comprises two parts—a 16-bit header value and a 32-bit key value. The 16-bit header is a fixed value used to prevent false-positives when decoding the consumer display image. The 32-bit key value is a lossless compressed version of a 6-character ASCII string. The characters are restricted to single-case letters of the alphabet for practical purposes and as such can be compressed into 5-bit chunks of the 32-bit key value (30 bits are used). Four 24-bit pixels are then encoded to represent the 48-bit code as such

The pixel numbers and components and corresponding code parts are listed for one mode of operation in Table 8.

TABLE 8

| Pixel (component) | Code part From bit:To Bit (inclusive) |
|---|---|
| 1 (blue) | Header 3:0 |
| 1 (green) | Header 7:4 |
| 1 (red) | Header 11:8 |
| 2 (blue) | Header 15:12 |
| 2 (green) | Key 3:0 |
| 2 (red) | Key 7:4 |
| 3 (blue) | Key 11:8 |
| 3 (green) | Key 15:12 |
| 3 (red) | Key 19:16 |
| 4 (blue) | Key 23:20 |
| 4 (green) | Key 27:24 |
| 4 (red) | Key 31:28 |

Each component's upper (most significant) 4 bits are encoded with each 4-bit code part. This allows for some reduction in the colour bit-depth of the display the image is rendered to (such as down to a 16-bit desktop).

Each screen file format is then encoded by loading the file into memory, decompressing it to produce a raw 24-bit colour image, encoding the 4 pixels, then re-compressing the image back into its original format and replacing the original file on the hard disk 6.

To encode graphical image formats such as JPEG or PCX, the algorithm need merely modify the four 24-bit pixels held in memory as contiguous component parts of pixels—8 bits each. However for HTML files, the pixels are encoded by adding a new ‘div’ in HTML script to the file, that describes the pixels to be drawn at the top-left corner.

Detection of the appearance of the pixels during a transaction or interaction is subsequently conducted in real time by the further application 38, by regularly reading the pixels rendered by Windows at the top-left corner of the display screen of the display device 8. The four pixels read are decoded into their header and key string constituent parts. If the header string matches a key string stored by the application 38 and representing a particular state, the key string is used by the application 38 to identify the state.

The decoding process may be conducted, for example, every 50 ms during operation. Every period, the application uses Win32 API calls to the Windows operating system 86 to retrieve the pixel data of those pixels rendered to the consumer display at the top-left corner (or slightly offset as required depending on ATM application behaviour). The pixel data is then decoded using a reverse of the encoding algorithm to produce the Header and Key values. The header is checked against the fixed value to ensure the key is valid and the key is checked against known, pre-defined options.

If there is a match, then the appropriate action for that encoded key is taken. For example, the application 38 may determine based on predefined conditions whether the identified state is one for which content should be sent to the display device 8 to replace or overlay the displayed screen.

By using the pixel encoding described above, state detection can be conducted in a timely manner by the embodiment of FIG. 2 so that the presentation of replacement screen or other content is conducted within an imperceptible delay after the rendering of an ATM interface screen. In variants of the embodiment, for selected stages the further application 38 waits for a predetermined delay period after detection of the change to a particular state before presenting the replacement screen or other content.

All ATM applications render screens but in varying formats. The pixel encoding can be applied to all known formats and can provide for platform-independent state detection, without requiring specific knowledge of the ATM application's state flow, rendering method, or timing. State flows can change without the need to reconfigure the encodings.

The further application 38 can detect almost instantaneously the identity of a screen and can, almost instantaneously replace that screen with an alternative screen (for example, replace a main menu screen with a favourites screen as discussed below). However, depending on the details of the system, the screen that is to be replaced may still be displayed for sufficient time for a user to notice its presence before it is replaced or, in some cases, for a user to notice a flickering effect due to the almost instantaneous display and replacement of the screen.

In variants of the described embodiment, the further application 38 sends an instruction to the display device to clip subsequent screens that are to be rendered by the device. For example, the further application 38 instructs the display device to clip subsequent screens so that only those four pixels that include the screen encoding are rendered initially. The further application 38 subsequently reads the four pixels that have been rendered and determines whether the screen is one that is to be displayed or whether it is to be replaced. If the screen is to be displayed the further application 38 sends an instruction to remove the clipping and the entire screen is then rendered. If the screen is to be replaced or overlaid, the further application 38 sends screen data to the device for rendering, thus to replace or overlay the screen in question. As the pixels that include the encoding are so few as to be almost imperceptible to the user, the distraction of having whole screens displayed and then immediately removed can be avoided and/or flicker or other distracting effects can be avoided.

The encoding and decoding techniques are not limited to those described above in relation to FIG. 2. For example, in the mode of operation described above, the state detection module requests rendered display data via Win32 API calls to the Windows operating system, for example to the DirectX or GDI API of the Windows operating system, whereas in alternative modes of operation the state detection module can intercept display data before it has been rendered, and after suitable processing to extract the encoded pixel values from the non-rendered data. That process is in general less efficient than extracting the pixel values from the rendered data. In other modes of operation the state detection module can address system components below the operating system in order to obtain the pixel values. The number and position of the pixels can also be varied. In many embodiments, the number and position of the pixels for encoding are selected so that the encoding, or differences in encoding between different screens, does not substantially affect the appearance of the display and/or is substantially imperceptible to the user. For example a small number of pixels may be used, and the pixels may be located at or near an edge or corner of the screen.

The further application 38 is downloaded from the server 5, or from a third party server, to the ATM 2 and installed. Display screens data, for example display screen templates, and other content to be provided to a user is also downloaded from the server 5, or from a third party server, and stored in the data store 6. The content can be packaged and compressed in a single file for distribution. In alternative embodiments, the content can be streamed from the server to the further application 38 when required. Upon installation, the further application generates and installs one or more of the proxy APIs or APIs 52, 60 as required. The further application 38 is operable to display full screen video or still images on the display device 6 in any suitable format. The further application 38 in the embodiment of FIG. 2 is platform independent, and is configured to run on multiple environments including Aptra, ProCash and Kalignite, all with or without web extensions, on any suitable hardware, including for example NCR, Wincor and Diebold ATMs and kiosks, and on using host communications protocol (for example NDC, 912)

The further application 38 in the embodiment of FIG. 2 is configured to use strong (128 bit) encryption in data communication. In addition the application 38 uses digital signing and hashing technologies to ensure that received data has come from a validated source and has not been compromised, and integrates with any existing virus protection software to scan all incoming data. The application 38 is configured to communicate over the network using TCP/IP, HTTP or HTTPS.

As mentioned above, it is a feature of the embodiment of FIG. 2 that the further application is able to control the state of the application 21 and/or a user interaction process by blocking, delaying or modifying messages from hardware or other devices, and by providing substitute, alternative or additional messages to the application 21.

By use of the screen data encoding, the state detection techniques and the control of the display device described above, the further application 38 is also able to monitor the state of a user interaction process and/or the state of the application 21, and to provide alternative display screens at appropriate points in a user interaction process. The further application 38 is able, for example, to select a stage of the user interaction process, monitor for occurrence of that stage using the monitoring module 84 and take control of the application of the user interaction process in response to that stage being reached.

The ability of the embodiment of FIG. 2 to monitor the state of the application and/or a user interaction process and automatically to take control of the process at any desired stage provides a powerful technique that can be used for a range of different applications.

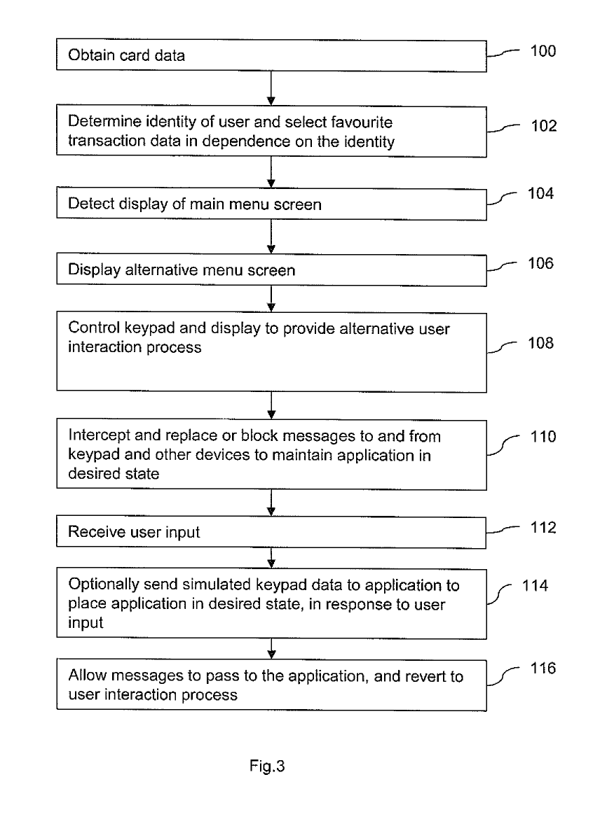

An example of one mode of operation of the embodiment of FIG. 2 is illustrated in overview in the flowchart of FIG. 3. In the mode of operation of FIG. 3, a menu screen of the usual user interaction process provided by the application 21 can be replaced automatically with a favourites menu screen that represents favourite transactions of a user.

At the first step 100, a user inserts their card into the user terminal 2. The card reader device 12 reads information from the card, and sends a message representing the information to the application 21 via the service provider module 44 and proxy API 60. The proxy API 60 forwards a copy of the message to the further application 38, and also allows the message to pass unamended to the application 21. The information includes cardholder name, Primary Account Number (PAN) and card ‘application’ (meaning issuer/institution responsible for the credit/debit processing, such as Mastercard or Visa).

The application 21 proceeds with a user interaction process in normal fashion and sends an instruction and associated image data to the display device 8, instructing the display device 8 to display a PIN entry screen on the display device 8. The application 21 also sends an instruction to the keypad device 10 instructing the keypad device to activate the number pad and control buttons ready for PIN entry by the user. The messages are sent to the display device 8 via the display driver 86 and to the keypad device 10 via the service provider module 42 and proxy API 52. The messages are allowed to pass unmodified, and the PIN entry process proceeds in normal fashion.

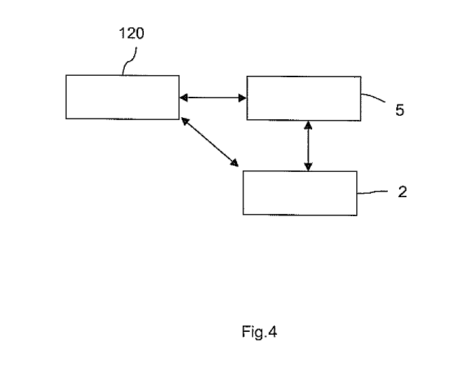

Meanwhile, the further application 38 sends a message to a remote server 120, either directly or via server 5. The message contains identification data that is associated with the user. The remote server 120 is shown in FIG. 4. The remote server 120 stores data concerning individual users, including preference data representing a user's preferences, and history data representing a user's history of user terminal usage or representing other activity associated for example with financial accounts or transactions. Alternatively the preference data and history data may represent preferences or history of a group of users to which the user belongs, based for example on one or more personal or financial characteristics of the user.

The preference data includes favourite transaction data representing a favourite transaction or transactions of the user. The preference data, including the favourite transaction data may be determined from history data associated by a user, or may represent a response by a user to a prior request for preference information. In the present example, the favourite transaction data represents a cash withdrawal of £20 and a cash withdrawal of £50 as those are the most common transactions that have been performed by that user on user terminals in the past. The favourite transaction data is sent by the remote server 120 to the further application 38.

In alternative embodiments, the preference data and/or history data may be stored at the server 5 or locally at the user terminal 2, and the further application 38 may obtain the preference data and/or history data from the server 5 or from local storage at the user terminal 2, rather than from the remote server 120.

The further application 38 processes the favourite transaction data and prepares menu screen data that can be provided at the appropriate juncture to the display device 8 to cause the display device 8 to display a favourites menu representing the favourite transactions of the user, in this case, a cash withdrawal of £20 and a cash withdrawal of £50. The menu also includes an option to return to a main menu.

Returning to operation of the application 21, and the user interaction process, once the PIN has been entered correctly by the user the application 21 sends a message to the display device instructing the display device to display a main menu screen of the user interaction process. As already discussed, the screen file representing the main menu screen includes an identifier in the form of a set of pixels that enable the state detection module 84 to identify that the display device 8 is displaying, or has been instructed to display, the main menu screen.

The state detection module 84 detects display of the main menu screen at step 106 and in response the further application 38 immediately instructs the display device 8 to display the favourites menu, overlaid on or replacing the main menu. The replacement or overlaying of the main menu is almost instantaneous in this case, and the user sees the favourites menu rather than the main menu.

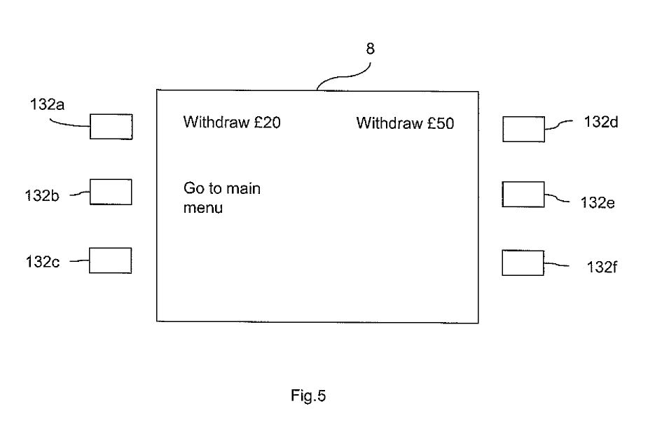

Each of the different options of the favourites menu are displayed aligned with different function buttons 132a, 132b, 132d that form part of a set of function buttons 132a-132f of the keypad device 10, as shown schematically in FIG. 5.

At step 108, the application 38 sends a message to keypad device 10 via proxy API 52 and service provider 42 activating the function buttons 132a, 132b, 132d thus enabling the user to select one of the displayed options (withdraw £20, withdraw £50, go to main menu). The controlling of the keypad and the display from this point onwards provides an alternative user interaction process that is different (for example comprising the display of different screens and/or the presentation of different options or a different sequence of options) from the user interaction process provided by the application 21 in normal operation. The further application 38 may also selectively activate or deactivate user input devices, for example at least one button or portion of touchscreen, during or as part of the alternative interaction process, and may monitor for user input from said selectively activated or deactivated user input device(s).

From the next step 110 onwards, the further application 38 instructions the proxy API 52 to block messages from the keypad device 10, via the service provider 42, from being passed to the application 21. Instead such messages are passed to the further application 38. Thus, even if a user selects one of the menu options by pressing one of the function buttons 132a, 132b, 132d, the application 21 is not aware that the function button has been pressed.

The further application 38 may also instruct other proxy APIs or other interception devices or units to block all, or selected, messages from passing from other devices to the application 21, thereby to maintain the application 21 in a particular state. In the present case the application 21 is maintained in a state corresponding to the main menu stage of the user interaction process. As far as the application 21 is aware the main menu continues to be displayed on the display device and input is awaited from the user.

The further application 38 may allow some messages to pass from hardware or other devices to the application 21 if receipt of such messages by the application 21 is necessary to maintain the application 21 in a desired state. For example, in some embodiments, it may be necessary to allow status messages from some devices (for instance generated by the devices in response to polling by the application 21) in order to maintain the application 21 in the desired state. The proxy APIs or other configuration devices, and the further application 38, are configured in such embodiments to selectively block or pass messages from devices to the application in order to maintain the application 21 in the desired state.

The processes performed by the further application in order to maintain the application 21 in a desired state, for example the main menu screen state, may depend on characteristics of the application itself. During the operation of the favourites feature, while the user is presented with the overlaid or otherwise presented favourites interface on the display device, the system in some embodiments needs to keep the ATM application ‘busy’ such that it doesn't terminate the transaction as it does not receive any response from the user for a threshold period of time. Normally, ATM applications will (if such a period of time elapses) present a new user interface screen offering the user the opportunity to request ‘more time’ to conduct the transaction, which, if selected, would result in the previous main menu or other options screen being presented again. If not selected or the user selects ‘no’ to the offer, the ATM transaction is terminated, and the card is returned.

To prevent the ‘no response’ sequence from occurring, in some embodiments if the ATM application 21 presents the ‘more time’ screen to the user while the further application 38 system is presenting the favourites user interface, the further application 38 system detects the state change represented by the attempted display of the ‘more time’ screen by the application 21 using screen monitoring or interception techniques as already described and automatically provides simulated keypress data to the application 21 to respond ‘yes’ to the offer. The ATM application 21 then returns to its main menu screen and the user experience is unaffected, as the display device continues to display screens as commanded by the further application 38 (without the knowledge of the application 21).

It can be understood from the preceding paragraph that maintaining the application 21 in a desired state may, in some embodiments, comprise returning the application 21 to the desired state, for example in response to any movement away from the desired state.

In alternative embodiments, measures are taken to prevent the application 21 from attempting to display the ‘more time’ screen, or otherwise move away from the main menu screen state or other desired state. In certain such embodiments, a hooking mechanism is used to modify code memory of an ATM application 21 process at runtime, for example by injecting code into a runtime stack, to redirect an attempt to execute an O/S API call and instead to execute alternative code not forming part of the ATM application 21. Such hooking mechanisms are used in some embodiments to alter timeout processes of the application such as a timeout process that causes the display of the ‘more time’ user interface screen mentioned above. Thus, normal attempts by the ATM application 21 to detect the elapsing of time can be prevented if desired.

Any suitable known hooking mechanism may be used, but in the present case the hooking mechanism modifies the behaviour of one or more of O/S API calls by the application 21 to time information returning methods such as ‘GetTickCount’ or ‘GetSystemTime’ (depending on which is used by the ATM application 21). The code injected into the code memory by the hooking mechanism returns a suitable time or count value (for example a low or zero time or count value) to ensure that the ATM application 21 does not time out. Thus, it can be ensured that the ATM application 21 does not attempt to display the ‘more time’ screen and remains in a desired state, for example a main menu screen state.

In an alternative embodiment, which does not use a hooking mechanism, the further application 38 uses a proxy API or proxy service provider module to intercept Windows timer calls from the application 21 and to return to the ATM application 21 appropriate time or count values to maintain the ATM application 21 in the desired state, for example a main menu state.

Whilst ensuring that the application 21 remains in the desired state, the further application 38 also monitors messages from one or more of the devices, in this example the keypad device 10, for messages indicating that the alternative user interaction process has moved, or is to move, to a new stage. In the present example, the further application 38 monitors for keypress data from the keypad device 10 that indicates that the user has pressed one of the function buttons 132a, 132b, 132d selecting one of the options from the favourites menu.

If the further application 38 determines that the keypress data indicates that the user has selected the option to return to the main menu, by pressing button 132b, then the further application at step 116 sends a message to the display device 8 to cause the display device to display the or a main menu screen.

The further application 38 also instructs the proxy APIs to allow messages from the hardware devices to pass to the application 21 unamended. In addition, the further application 38 sends a message to the keypad device 10 to activate the buttons that may be pressed by the user in order to select options from the main menu screen. The further application then allows the user terminal to revert to the normal user interaction process under control of the application 21.

If at step 112 the further application 38 receives keypress data that indicates that the user has selected one of the other options, for example withdraw £20, then the further application 38 takes action to provide that the requested amount, in this case £20, is dispensed to the user. In order to do so, in the mode of operation of FIG. 3, the further application 38 sends control data in the form or further keypress data to the application 21 to place the application 21 in a desired state.

In this case the further application 38 sends a first set of further keypress data to the application 21 that represents the pressing of a button selecting a “Withdraw cash” option of the main menu. The further keypress data may be referred to as simulated keypress data as it is substantially or identically the same as keypress data that would be generated by the user actually pressing a button (in this case the button to select the “withdraw cash” option of the main menu screen).

The application 21 responds to the simulated keypress data by sending further control data, in the form of an instruction to the display device 8 to display a cash withdrawal menu screen presenting different possible cash withdrawal amounts. The state detection module 84 detects the display of the cash withdrawal menu by, or the sending of display data representing the cash withdrawal menu to, the display device 8. In response the further application 38 immediately instructs the display device 8 to display an alternative screen, for example to redisplay the favourites menu screen or to display a further alternative screen (for example a screen stating “Your cash is being dispensed”).

The further application 38 also sends further simulated keypress data to the application 21, immediately following the simulated keypress data that selected the cash withdrawal menu. The further simulated keypress data simulates the pressing of a button by the user selecting a withdraw £20 option from the cash withdrawal menu.

The further application then performs the actions of step 116 as already described, and stops the blocking of messages to the application 21 and allows the usual user interaction process of the application 21 to resume. As the application 21 has just received simulated keypress data indicating selection of withdrawal of £20 it proceeds by sending a message to a cash dispenser of the user terminal 2 to dispense the £20 amount and continues with the user interaction process as normal from that stage.

It can be understood from the above description that in embodiments the application 38 can determine an outcome of the alternative interaction process, for example determining a desired or requested action, and can perform the desired or requested action by, for example, sending control data to the application 21 to make the application 21 perform or request the desired or requested action.

In an alternative mode of operation, the further application 21 sends further control data in the form of a message sent directly to the cash dispenser itself to instruct the dispensing of the £20 amount. Further simulated keypress data is then sent by the further application 38 to the application 21 to place the application 21 in state corresponding to a later stage (after dispensing of the £20) of the normal user interaction process, and the normal user interaction is then resumed at that later stage.

By taking control of the user interaction process from the ATM application 21 as described in relation to FIG. 3, the further application 38 is able to replace the main menu of the normal user interaction process with a favourites menu, thus improving or changing the user experience of use of the user terminal 2 and potentially reducing the duration of the interaction of the user with the user terminal 2. The further application 38 can be installed on the user terminal without affecting the configuration or installation of the application 21. Indeed the application 21 can operate in accordance with its usual sequence of operations, without awareness that the further application 38 is present even though the further application 38 may have taken control of hardware or other devices from the application 21. The functionality of the user terminal 2 can be improved or otherwise modified, for example to provide an alternative user interaction process, substantially without modifying existing software and/or configurations. In some cases, the entire user interaction process of the application 21 may be replaced by an alternative user interaction process of the further application 38, by operation of the further application 38 and associated proxy APIs or other interception devices or units. Alternatively any selected stage or stages of the user interaction process provided by the application 21 can be replaced by an alternative stage or stages provided by the further application 38.

It will be understood that the presentation of a favourites menu described in relation to FIG. 3 represents one example of an alternative user interaction process that can be provided by the embodiment of FIG. 2. The sending of control data, for example comprising simulated keypress data or other simulated user input data, from the further application to the application enables the further application to place and maintain the application in any desired state.

The further application may send other control data to the application as well as or instead of simulated keypress data. The control data may comprise any data that affects the operation of the further application, for example any data that causes the application to move to or remain in a desired state. The control data may comprise simulated data representing data that may be obtained from any hardware device of the user terminal and is not limited to being simulated keypress data or other data that may be obtained from the keypad device. The control data may comprise at least one instruction and/or may comprise status data, time data or content data.

The use of a hooking mechanism has been described above in relation to the prevention of timeouts in some embodiments. Such hooking mechanisms are also used in some embodiments to provide alternative state detection methods. By injecting code into the ATM application runtime code memory, for example a runtime stack, the ATM application's 21 normal attempts to access stored files, such as screen files can be redirected or blocked. Thus the further application 38 can, for example, pre-empt the ATM application 21 rendering the user interface screen contents (held in a file) to the display device. This also allows the further application 38 to obtain knowledge concerning the state the ATM application 21 intends or is about to change to, giving the further application 38 more time to take action such as, for example, displaying or removing user interface screens or parts of screens, for example overlaid display elements, or locking the application 21 in a particular desired state.

Hooking mechanisms can be used to obtain information about attempted execution by the ATM application 21 of a variety of API calls, which can lead to other decisions or actions by the further application 38 in response to such information. For example, the further application 38 can decide whether to execute the original API call or instead to conduct some other action, or can control the system such as to return alternate information to the ATM application 21 than would otherwise have been returned by the API.

For example, in certain embodiments a hooking mechanism is used to prevent the ATM application 21 from executing certain O/S API calls whilst the further application 38 conducts a favourites transaction, an automated transaction on behalf of the user, or other alternative transaction process. For instance, in some embodiments, the ATM application 21 may attempt to conduct an audible system ‘beep’ using an O/S API call in reaction to the simulated key presses that are provided to the ATM application 21 under control of the further application 38. However it is undesirable to have the ATM produce an audible beep or other audio output when in fact the user is not conducting a key press, and the code inserted into the runtime stack by the hooking process can be configured to prevent such beep instructions or other audio instructions from the ATM application 21 from being performed.

Embodiments have been described in which a favourites menu is displayed to the user in place of the ATM application's 21 main menu or other transaction screen. Any other customised, replacement or modified screen can be displayed under control of the further application 38 in alternative embodiments, without the knowledge of and without altering the state of the ATM application 21. In certain embodiments, the user's current balance or other account information (for example, overdraft limit or available funds) or personal information is displayed automatically on the customised, replacement or modified screen. Such information can be displayed without the customer requesting it each time a transaction is conducted, but may be provided as part of a pre-established or default customer preference.

In embodiments, the balance information can be obtained by performing an automated transaction under the control of the further application 38 by providing simulated keypress data, simulated screen touch data or other simulated user input data to the application 21, which causes the application 21 to send a balance request to the server 5 or other financial transaction host. The user is not aware that a transaction is being conducted, as they are presented with an overlaid screen (for example an overlaid favourites or other screen) rather than a balance enquiry process screen that the application 21 attempts to (and considers that it is) displaying. While the balance is being acquired, a suitably user-friendly message can be displayed to the user on the displayed screen. Once the balance is acquired, the message is replaced with the balance information.

The ATM application 21 attempts to present the balance information on the display device, but is blocked or overlaid under control of the further application 38, for example using the proxy service provider module or other blocking or overlaying technique as described above. The balance information is extracted and displayed on the overlaid user interface (for example the favourites transaction screen) in an appropriate style at an appropriate position.

Various methods can be used to acquire the balance information under control of the further application 38 according to different embodiments. One method uses ‘code injection’ or ‘hooking’ techniques similar to those described above. One of the API calls that can be hooked is used to render the alphanumeric characters that represent the balance information, to the display device using standard O/S rendering methods. Using this code injection method, the original ASCII characters can be captured and utilised to display balance information in the correct style on the overlaid interface (for example a favourites transaction screen).

In an alternative embodiment, the actual rendered image of the balance display generated by the ATM application 21 (for example, after the ASCII characters have been processed by the O/S API) is intercepted. This is then converted back into ASCII characters, for example using off-the-shelf OCR technology, and then subsequently rendered to the display device under control of the further application 38.

In further alternative embodiments, the transfer of the balance information through the ATM application is intercepted at a different point in the data path from financial transaction host response to display device.

In the mode of operation described in relation to FIG. 3, the favourites menu represents favourite transactions of a user. The favourite transactions may be determined from history data for example representing a user's history of user terminal usage or representing other activity associated for example with financial accounts or transactions. In some embodiments such history data may be provided by a financial institution or user terminal network operator based on usage data logged by the ATM application 21 or the server 5. In alternative embodiments the usage data for individual users is logged by the further application 38 based on messages received by the proxy APIs or other interception devices or units and passed to the further application 38 for logging and/or analysis. In such embodiments the logged data may be transmitted to the server 120 either before or after analysis. A record of usage by individual users can be built up by the server 120 over time. The usage data may be obtained and analysed independently of usage data obtained by the user's account-holding financial institution or user terminal network operator. Thus, for example, favourites data may be obtained, and favourites menus generated, independently of operation of the ATM application 21 and/or server 5.

The logged data may comprise user input data, for example keypress data and/or touchscreen data. The logged data may also comprise data representative of the stage of the user interaction at which the user input occurred, for example data representative of the screen displayed at the time the user input was obtained, for instance screen encoding data as described or other screen identifiers.

In certain embodiments the further application 38 is configured to collect the user input data using techniques as described herein. For example, the further application 38 can read messages sent between the hardware devices, for example the keypad or touchscreen using the proxy techniques described herein, and obtain keypress data or screen touch data, or other user input data from the messages. From the user input data the further application 38 is able to determine a sequence of user inputs that have occurred and from the user inputs determine usage data that represent usage, for example a transaction that has taken place (for example, balance enquiry, withdrawal of £20, withdrawal of £50 or withdrawal of some other amount). The usage data can be determined by the further application 38 using a schema or mapping stored at the user terminal, and accessible by the further application 38, that represents the sequence of user interfaces that may be displayed to the user and the actions performed in response to particular user inputs. The further application 38 can determine from the user inputs and the schema the particular transaction that corresponds to a particular sequence of user inputs.

The further application 38 then associates the usage data with the user in question, and transmits the usage data, either each time a transaction is performed or periodically, to the remote server 120. In this case, the remote server is associated with an entity responsible for installation and operation of the further application 38 and is distinct and remote from the server 5 that is operated by a user terminal network entity, for example a financial service provider that provides financial services via the user terminal.

The remote server 120 is then able to process the usage data to determine user history or user favourites for each individual user. Subsequently, the remote server 120 is able to transmit favourites data or other user data to the further application 38, either in response to a transaction by the user, or periodically for local storage at the user terminal as part of a collection of data for a large number of users. In alternative embodiments the raw user input data is transmitted from the further application 38 to the further server 120, and the further server 120 determines the usage data from the raw user inputs based on the schema or mapping for that user terminal.

It can be understood that recording of user inputs according to particular embodiments involves using the state-detection technology already described and interception of the user's key presses (or screen ‘touches’ or other user input data) to determine which transaction flow the user is conducting. These detection technologies are independent of the ATM application and do not require any modification of the ATM application software by the software vendors. Using a pre-configured mapping, the combination of states and key presses is translated into a transaction (such as ‘£50 cash withdrawal with printed receipt). This information is sent to a server, for example an independent server, where a history of transactions for a particular user (defined by the user's card data) is determined. When the favourites menu is to shown to the user again, the history of transactions is processed by an algorithm and a list of ‘favourite’ transactions is presented.

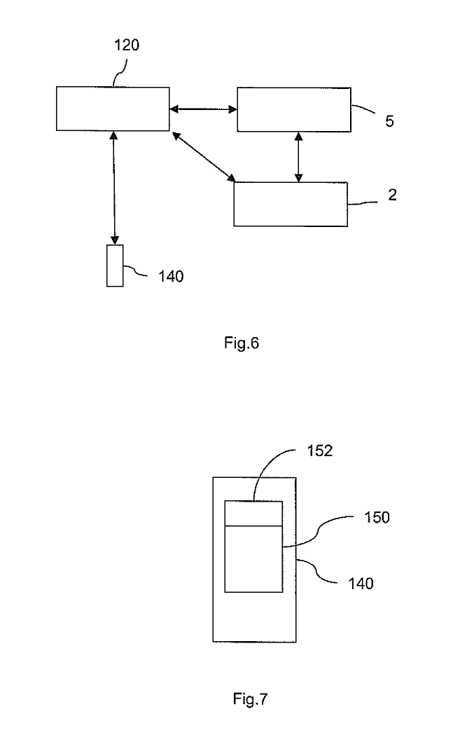

Another application of the embodiment of FIG. 2 is now described in relation to FIGS. 6 to 8. FIG. 6 shows a system in one embodiment in which the user has a mobile device 140 that is operable to communicate with the remote server 120. The mobile device in this case is a smart phone but may comprise any other type of mobile phone, mobile device or other remote device in alternative embodiments.

The mobile phone 140 includes an operating system and software 150 that, in this case, provides the usual functionality of a smart phone. The mobile phone 150 also includes an additional component 152, in the form of an application, app or other software, which is configured to allow a user to request user terminal transactions or other user terminal interactions.

The additional software may be downloaded from the server 120 for installation on the mobile phone 140. The additional software allows the user to request a particular transaction from a user terminal (for example, withdrawal of a particular cash amount) in advance of their interaction with the user terminal. For example, the user may use the additional software to request withdrawal of, say, £20 before they have inserted a card into the user terminal, or used some other verification device such as a fob, contactless card or other contactless device, to begin interaction with the user terminal. Thus, the user may request withdrawal of the selected cash amount, or request some other transaction, whilst they are queuing to use the user terminal or travelling to the user terminal.

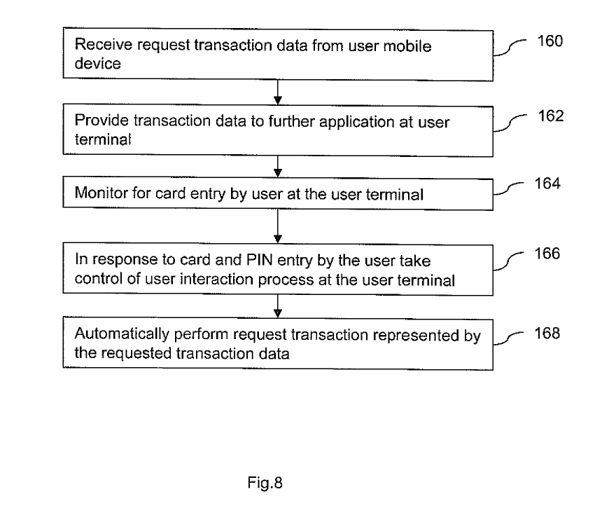

A process, in one mode of operation of the embodiment of FIG. 6, for requesting in advance a transaction using the mobile device and subsequently controlling a user terminal automatically to perform the transaction is illustrated in overview in the flowchart of FIG. 8.

At the first step 160, a user enters a desired transaction using the additional software 152 of the mobile phone 140. The additional software 152 is operable to provide a user interface to the user via the mobile phone 140. The user interface may be of any suitable form to provide the desired functionality and may, for example, comprises a series of interlinked menus for selecting a transaction similar to those provided by the user terminal itself.

The user interface provided by the additional software 152 also provides a user interface for allowing the user to select a particular user terminal, and the user selects a particular user terminal or terminals using the interface. The interface may comprise a text box or drop-down menu to allow the user to enter or select the location of a particular user terminal. Alternatively, the user interface may comprise a map showing user terminals near to the user's current location or a selected location, and the user may select one of the terminals shown.

In an alternative mode of operation, the mobile phone 150 includes means for determining the current location of the user, for example using known techniques such as GPS or triangulation from the location of nearby mobile phone base stations. That current location can subsequently be used to select automatically one or more user terminals that the user is likely to use.

After the user has selected a particular transaction, for example withdraw £20 in this case, and one or more user terminals, requested transaction data representing the requested transaction and the selected user terminal(s) (or the current location of the user) is transmitted by the mobile phone 140 to the server 120. The data in this example is transmitted to the server 120 from the mobile phone 140 via text message but any suitable mode of communication can be used.

The server 120 processes the received requested transaction data and determines the identity of the user, for example using a database that maps mobile phone numbers or other mobile device identifiers to user and/or account identifiers. If the user has not selected a particular user terminal, the server 120 may also identify from location data received with the message from the mobile phone 140 one or more user terminals that the user is like to use based on their current location.

At the next step 162, the server 120 transmits to the further application 38 of the selected user terminal 2 data representing the transaction requested by the user and a user and/or account identifier.

The further application 38 then, at step 164, monitors for insertion of a card by the identified user by monitoring data received by the proxy API 60 from the card reader device 12.

In response to detecting that the identified user has inserted their card and has entered their PIN correctly, the further application 38 at step 166 then takes control of the transaction process as described in relation to steps 108 and 110 of the process of FIG. 3, and provides an alternative interaction process.

The further application, at step 168, sends simulated keypress data to the application 21. The simulated keypress data indicates to the application 21 that a user has pressed buttons selecting a cash withdrawal option from the main menu and subsequently selecting withdrawal of £20 (even though the user has not made those keypresses). In response the application 21 sends a message to a cash dispenser of the user terminal 2 to dispense the requested £20. The further application 38 instructs a proxy API associated with the cash dispenser to allow the message to pass to the cash dispenser, which then dispenses cash. In some embodiments no such proxy API for the cash dispenser is present in which case the message will pass directly to the cash dispenser.

The further application 38 then allows messages to pass to and from the application 21 and reverts to the usual user interaction process, as described in relation to step 116 of the process of FIG. 3.

During steps 166 and 168 the further application also monitors the screens that the application 21 instructs the display device 8 to display, and replaces or overlays those screens with alternative screens as part of the alternative transaction screen. In one mode of operation the screen displayed under control of the further application 38 confirms that the user terminal is processing the transaction requested in advance, for example stating “We are processing your request for withdrawal of £20”.

From the user's perspective, when the user provides their card (or other verification device) to the user terminal 21 they are presented with the normal PIN entry screen provided by the application 21 as part of the normal user interaction process. The user next sees the replacement screen stating “We are processing your request for withdrawal of £20”. The user terminal then returns to the usual transaction process under control of the application 21, as described, and the cash dispenser then dispenses the £20 and at the same time the display device 8 displays the usual screen associated with cash dispensing (stating for example “Please wait for your cash”). A final screen of the usual user transaction process is then displayed under control of the application 21, for example stating “Please take your card and cash. Thank you for your custom”. The card is expelled by the card reader device 12 and the cash is dispensed by the cash dispenser.

The process of FIG. 8 enables the user to obtain cash, or perform another desired transaction, with a minimum number of button presses or other actions at the user terminal. For example, in the process described in relation to FIG. 8 the user is able to obtain withdrawal of £20 (or other amount) whilst, at the user terminal, only inserting their card, entering their PIN and pressing an enter button. The remainder of the process is automated based on the transaction request earlier provided by the mobile phone 140.

The user terminal processes that can be requested in advance by the user via a mobile device are not limited to cash withdrawal. Any suitable user process can be requested in advance by the user, including for example balance enquiries, report or receipt printing, cash deposit. Indeed, any process that can be performed using the user terminal can be requested in advance using the mobile device 140.

The system may comprise a synchronisation module or unit in some embodiments. The synchronisation module or unit is configured to synchronise actions performed or instructed by the further application with operation of the application 21, the hardware devices or other components. The synchronisation module or unit may form part of the further application.

The synchronisation module or unit may be configured to select the time at which instructions or other control data, or content, are sent by the further application or by the proxy APIs, or other interception devices or units, to ensure a desired response by the intended recipient (for example the application 21 or the hardware devices) is obtained. For example, in a situation where a sequence of instructions or other control data is sent to the application 21 (or to a hardware device or other component) the synchronisation unit may provide a delay between the sending of each successive instruction or set of control data to ensure that the application 21 (or hardware device or other component) has processed the preceding instruction or set of control data and is ready to receive the next instruction or set of control data. The synchronisation module or unit can be particularly useful in connection with the sending of a succession of different sets of simulated keypress data to the application 21 each set representing a different keypress, for example keypresses associated with different menu screens. In ordinary operation, where keypress data is provided by a user by pressing keys the application 21 would usually expect there to be a delay between receipt of different sets of keypress data. The synchronisation module or unit can ensure that there is a sufficient delay between successive sets of simulated keypress data to ensure that they are processed correctly by the application 21.

Although in the embodiment of FIG. 2, the normal user interaction process is controlled by an application and the alternative user interaction process is controlled by a further application, in alternative embodiments any suitable other controller may be used in place of the application and any suitable other further controller may be used in place of the further application. The controller and the further controller may comprise software, hardware or any suitable combination of software and hardware.

The control data may be provided by the further application or other further controller, or may be provided by another source, for example a data store, for instance under control of or forming part of the further application or other further controller.

The user terminal may comprise any suitable devices, for example at least one of a user input device, for example a keypad device and/or at least one button; a display device; a cash dispenser device or other dispenser device; a card reader device or other device for reading verifying the identity of a user for instance a reader for reading a contactless card or fob; a camera. Each of the devices may be a non-XFS device or an XFS device.

In alternative embodiments, any suitable user input device may be used as well as or instead of a keypad. For example, the user input device may comprise a touchscreen device that is used both to render screens and to obtain user input by the pressing of areas of the display by a user.

The touchscreen may, for example, be a non-XFS device in some embodiments. In some such embodiments the touching of the screen in particular areas can be determined by the further application 38 by, for example by appropriate Windows API calls or function calls. In some such embodiments, the application 21 displays screens on a first window on the display device, and the further application 38 displays screens on a further window overlaid on that first window. As the further window is active and overlaid on top of the first window, screen presses by a user do not cause user input data to be sent to the application 21. Instead the position of the screen presses can be determined by the further application via API or function calls and the resulting position data can be used by the further application to determine the nature of the user input, for example which option has been selected by a user.

In the described embodiments messages between various components are redirected and/or intercepted. The messages may be in any suitable format, and may comprise one or more data packets or a stream of data packets.

Alternative embodiments of the invention can be implemented as a computer program product for use with a computer system, the computer program product being, for example, a series of computer instructions stored on a tangible data recording medium, such as a diskette, CD-ROM, ROM, or fixed disk, or embodied in a computer data signal, the signal being transmitted over a tangible medium or a wireless medium, for example, microwave or infrared. The series of computer instructions can constitute all or part of the functionality described above, and can also be stored in any memory device, volatile or non-volatile, such as semiconductor, magnetic, optical or other memory device.

The display of a favourites menu has been described but it will be understood that in alternative embodiments or modes of operation any suitable personalised menu or other screen may be displayed.

The embodiment of FIG. 2 relates to an ATM, but alternative embodiments may be implement using, or comprise, any other suitable type of user terminal, for example, user terminals for the purchase of goods and services, for example purchase of fuel, purchase and/or dispensing of food or other items, payment for parking or other services.

It will be well understood by persons of ordinary skill in the art that whilst the embodiments described herein implement certain functionality by means of software, that functionality could equally be implemented solely in hardware (for example by means of one or more ASICs (application specific integrated circuit)) or indeed by a mix of hardware and software. As such, the scope of the present invention should not be interpreted as being limited only to being implemented in software.

It will be understood that the present invention has been described above purely by way of example, and modifications of detail can be made within the scope of the invention.

Each feature disclosed in the description, and (where appropriate) the claims and drawings may be provided independently or in any appropriate combination.

1. A method of controlling operation of a user terminal, wherein the user terminal comprises a controller for controlling operation of the user terminal, and the user terminal further comprises a plurality of devices, wherein in normal operation the controller is responsive to data received from at least one of the devices, and the method comprises:
providing, from a source other than said at least one of the devices, control data to the controller, the control data comprising data that the controller interprets as being received from said at least one the devices.

2. A method according to claim 1, wherein at least one of:
the user terminal comprises an ATM;
the controller comprises an ATM application; or
the source comprises a further controller.

3. A method according to claim 1, wherein at least one of:
the control data comprises simulated data that simulates data that may be received from said at least one of the devices; or
the control data is in the same or similar format as data that may be received from said at least one device.

4. A method according to claim 1, wherein at least one of:
a) the control data is in the same or similar format as user input data;
b) the control data comprises simulated keypress data or simulated screen touch data; and
c) the control data is configured to place the controller in a desired state and/or to cause the controller to perform at least one desired action.

5. (canceled)

6. (canceled)

7. A method according to claim 1, comprising providing further control data and/or content to at least one of said plurality of devices under control of the source, wherein the further control data comprises simulated data that simulates data that may be provided by the controller in normal operation.

8. A method according to claim 7, wherein the further control data is in the same or similar format, and/or has the same or similar content as instructions that are provided by the controller to instruct actions forming part of a user interaction process.

9. A method according to claim 1, wherein the source is configured to provide the control data to the controller and/or to provide data to at least one of the devices, thereby to replace at least part of a user interaction process controlled by the controller with an alternative interaction process controlled by the source.

10. A method according to claim 9, wherein at least one of:
a) the alternative interaction process comprises displaying at least one alternative user interface;
b) blocking, delaying, modifying or replacing at least one message from at least one of the control devices to the controller, thereby to maintain the controller in a desired state whilst the alternative interaction process is performed;
c) the content and/or timing of the provided control data and/or other data ensures that the controller is not aware of at least part of the alternative interaction process;
d) the alternative interaction process comprises display of a personalized menu or other screen to a use; and
e) the alternative interaction process comprises display of a favorites menu.

11. (canceled)

12. (canceled)

13. (canceled)

14. (canceled)

15. A method according to claim 10, comprising at least one of:
a) identifying a user and providing the personalized menu or other screen in dependence on the identity of the user; and
b) determining the personalized menu or other screen in dependence on a usage history.

16. (canceled)

17. A method according to claim 15, wherein the usage history comprises a history of transactions performed using user terminals of a network of user terminals.

18. A method according to claim 2, comprising collecting usage data for a plurality of users by the further controller.

19. A method according to claim 9, further comprising obtaining a user request for a transaction via a mobile device or remote user device, wherein the alternative interaction process comprises automatically performing the user request.

20. A method according to claim 19, comprising obtaining the user request in advance of the user interacting with the user terminal.

21. A method according to claim 20, comprising at least one of:
a) monitoring for the user to begin interacting with the user terminal and automatically performing the user request in response to the user beginning to interact with the user terminal;
b) automatically performing the user request in response to a user interaction process of the user with the user terminal reaching a predetermined stage; and
c) receiving the user request at a server, identifying at least one user terminal where the user may wish the request to be performed and selectively transmitting user request data to the identified at least one user terminal.

22. (canceled)

23. (canceled)

24. A method according to claim 21, wherein the user request received at the server comprises or is associated with location data representative of a present location or expected future location of the user and/or mobile device or remote device, and the method comprises identifying the at least one user terminal in dependence on the present location or expected future location.

25. A method according to claim 9, wherein at least one of:
a) the source is configured to perform automatically a balance enquiry to obtain balance data, and the alternative interaction process comprises displaying the balance data; and
b) the alternative interaction process comprises at least one of a cash withdrawal transaction process, a cash deposit transaction process, a balance enquiry.

26. (canceled)

27. A method according to claim 1, wherein:
the controller is configured to control operation of the user terminal to provide a process comprising the display of a sequence of display screens, each display screen represented by content data provided under control of the controller;
the content data comprises pixel data items representative of pixels to be displayed on the display device, at least one of the pixel data items comprising or representing an identifier, the method comprises performing a clipping process so that only a subset of pixels are rendered by the display device, the subset of pixels comprising said pixel data items representing said identifier; and
the method comprises reading said at least one of the pixel data items to determine said identifier.

28. A method according to claim 27, wherein at least one of:
a) identifying a display screen using the identifier, or determining from the identifier at least one of a stage of the process or a state of the controller; and
b) the identifier is encoded on the value of the said at least one pixel data item.

29. (canceled)

30. A method according to claim 27, wherein the method comprises, in response to determining from the identifier that the content data is to be displayed, removing the clipping.

31. A method according to claim 1, further comprising installing the source in the user terminal without affecting the configuration of the controller.

32. (canceled)

33. A method according to claim 2, wherein the further controller comprises at least one further device for blocking, delaying, modifying, redirecting or replacing at least one message sent between the controller and the least one device.

34. A method according to claim 33, wherein the at least one further device comprises at least one of an API, a DLL, a service provider module, a proxy API, a proxy DLL, a proxy service provider module, a hooking mechanism.

35. A method according to claim 1, wherein at least one of:
a) the control data provided to the controller comprises time data for modifying the timing of an operation by the controller;
b) the providing of the control data to the controller is such as to respond to or prevent a timeout process of the application; and
c) the control data is configured such as to prevent a beep, or other audio output operation.

36. (canceled)

37. (canceled)

38. A method according to claim 1, wherein at least one of:
a) the providing of the control data to the controller comprises inserting code into runtime memory; and
b) modifying at least one registry key and/or inserting code into runtime memory to replace or modify code in the runtime memory from the controller.

39. (canceled)

40. A system for controlling operation of a user terminal, wherein the user terminal comprises a controller for controlling operation of the user terminal, and the user terminal further comprises a plurality of devices, wherein in normal operation the controller is responsive to data received from at least one of the devices to perform a user interaction process, and the system comprises a further controller for providing control data to the controller, the control data comprising data that the controller interprets as being received from said at least one of the devices.

41. (canceled)

42. (canceled)

43. (canceled)

44. (canceled)

45. A system according to claim 40, wherein the user terminal controller is configured to communicate with a remote server and the further controller is configured to communicate with a further server remote from the user terminal.

46. A system according to claim 45, wherein at least one of:
a) the further controller is configured to collect usage data representative of at least one transaction by a user, and to provide the data to the further server;
b) the usage data comprises or is derived from application state and/or user input data; and
c) the further server, wherein the further server is configured to determine user history or user favorites for at least one user in dependence on the usage data.

47. (canceled)

48. (canceled)

49. A system for monitoring operation of a user terminal, wherein the user terminal comprises a controller for controlling operation of the user terminal, the user terminal further comprises a plurality of devices, and the controller is configured to control at least one user interaction process, and the system comprises:
a monitoring device that is configured to at least one of read, block, delay, modify, redirect or replace at least one message sent between the controller and the at least one device, wherein the monitoring device is configured to collect usage data representative of at least one transaction by a user.

50. A system according to claim 49, wherein at least one of:
a) the usage data comprises or is derived from user input data, for example keypress data or screen touch data obtained from the at least one message; and
b) the monitoring device is configured to transmit the usage data to a remote server.

51. (canceled)

52. (canceled)

53. (canceled)

54. (canceled)

55. A non-transitory computer-readable medium comprising a memory storing instructions that are executable to control operation of a user terminal, wherein the user terminal comprises a controller for controlling operation of the user terminal, and the user terminal further comprises a plurality of devices, wherein in normal operation the controller is responsive to data received from at least one of the devices, and the method comprises:
providing, from a source other than said at least one of the devices, control data to the controller, the control data comprising data that the controller interprets as being received from said at least one the devices.
